(19) United States
(12) Patent Application Publication
(10) Pub. No.: US 2025/0147986 A1
(43) Pub. Date: May 8, 2025

(54) ANALYTICS SERVICE GOVERNANCE

(71) Applicant: Oracle International Corporation, Redwood City, CA (US)

(72) Inventors: Nikhil Surve, San Ramon, CA (US); Anitha Ramarao, Bangalore (IN); Paul Stephen Benedict, Minnetonka, MN (US); Douglas John Marshik, Champlin, MN (US); Amarpreet Singh Nagra, Tracy, CA (US); Sesha Sailendra Kona, Hyderabad (IN)

(21) Appl. No.: 18/502,861

(22) Filed: Nov. 6, 2023

(51) Int. Cl. G06F 16/28; G06F 16/26

(52) U.S. Cl. CPC G06F 16/287; G06F 16/26

(57) ABSTRACT

Various embodiments of the present technology generally relate to systems and methods for providing an analytics service governance system to provide data visualizations of system-level metadata. In certain embodiments, a method may comprise operating a data analytics system to implement an analytics service governance process to generate data visualizations (DVs) of system-level metadata using an analytics service configured to generate DVs of user-provided datasets. The analytics service governance process may include establishing a connection to an analytics system database containing the system-level metadata as a dataset, generating a governance dashboard providing access to pre-generated DV options based on selected metadata related to user-created objects in the analytics system database, receiving a user selection of object categories and filters from pre-generated DV options, and producing a governance DV based on the user selection depicting a relationship of objects at the system level from the object categories.

### TECHNICAL FIELD

Various embodiments of the present technology generally relate to the generation and presentation of data visualizations via a data analytics service. More specifically, embodiments of the present technology relate to systems and methods for generating data visualizations based on a system-level metadata dataset to enable analytics system governance.

### BACKGROUND

In data analytics software environments such as Oracle Analytics, users or clients (such as individuals, businesses, or data analytics software consumers) may enter, upload, or link data, which the software may transform or clean into datasets having a unified format. The transformed data may then be used to generate visualizations, such as graphs, charts, diagrams, or other visual data depictions. Users may create or manage various catalog or database objects, like connections, datasets, schedulers, dataflows, etc. Data analysis of user data may be used to provide insightful connections and depictions of how various data fields may be related for business administration, scientific studies, or other applications.

A data analytics system or service may provide the software or technical resources to implement a data analytics environment. Companies or other entities may run their own private instance of a data analysis service, either hosted remotely in the cloud or locally as an on-premises instance. An administrator of an analytics instance may manage roles, access rights, security credentials, or other authorizations for users of the instance, and may configure various system settings or parameters for the instance, such as backup settings, patch updates, or other settings.

However, an analytics system administrator may have no system wide view of objects within an analytics service instance. System-level metadata and object information is stored within an analytics system database that is used to run the analytics instance, but may not be available to users or even administrators. Some information in the analytics system database may be protected for system security, for user security or privacy, or for other reasons. Because of this, while some questions related to objects can be answered easily, others cannot be answered at all. For example, there may be no way to map the relationships between various objects within the system, which may be very valuable under many situations while monitoring and maintaining the system. Administrators may be unable to answer questions such as “who are the top analytics users,” “which are the most commonly run scheduled reports,” “why is the analytics instance performance impacted at a specific time”, and “can I get an analysis of workload on the analytics system over a time period”. The lack of system-wide information may make it challenging for administrators to solve problems or make decisions to handle real time situations. Accordingly, there exists a need for improved analytics system governance features.

The information provided in this section is presented as background information and serves only to assist in any understanding of the present disclosure. No determination has been made and no assertion is made as to whether any of the above might be applicable as prior art with regard to the present disclosure.

### BRIEF SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments herein relate to systems, methods, and computer-readable storage media for performing configuration data management. In an embodiment, a data analytics system may comprise one or more processors, and a memory having stored thereon instructions that, upon execution by the one or more processors, cause the one or more processors to implement an analytics service governance process to generate data visualizations (DVs) of system-level metadata using an analytics service configured to generate DVs of user-provided datasets. The data analytics system may establish a connection to an analytics system database containing the system-level metadata as a dataset, generate a governance dashboard providing access to pre-generated DV options based on selected metadata related to user-created objects in the analytics system database, receive a user selection of object categories and filters from pre-generated DV options, and produce a governance DV based on the user selection depicting a relationship of objects at the system level from the object categories.

In some embodiments of the data analytics system, the system-level metadata may include system information generated by operation of the analytics service and required for the analytics service to function. The system-level metadata includes information about system-wide objects. In some embodiments, the system-level metadata includes protected information not accessible to users, and the pre-generated DV options based on the selected metadata are configured to not expose the protected information. In certain embodiments, the data analytics system may establish the connection to the analytics system database via a hidden connection configured so that the analytics system database is not directly queryable by users. The data analytics system may, in some examples, determine whether a user accessing the analytics service is an administrator having access rights to the governance dashboard, and withhold access to the governance dashboard when the user is not an administrator. In some embodiments, the governance DV may depict information about objects that influences a performance metric of the analytics service. The data analytics service may be deployed as a cloud-based service, or the analytics service may be deployed as an on-premises service. In some examples, the data analytics system may add the governance DV to the governance dashboard, and add additional DVs produced based on the selected metadata from the analytics system database to the governance dashboard.

In an alternative embodiment, a method may comprise operating a data analytics system to implement an analytics service governance process to generate data visualizations (DVs) of system-level metadata using an analytics service configured to generate DVs of user-provided datasets. The analytics service governance process may include establishing a connection to an analytics system database containing the system-level metadata as a dataset, generating a governance dashboard providing access to pre-generated DV options based on selected metadata related to user-created objects in the analytics system database, receiving a user selection of object categories and filters from pre-generated DV options, and producing a governance DV based on the user selection depicting a relationship of objects at the system level from the object categories.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein.

FIG. 1 is a diagram of a system configured to implement analytics service governance, in accordance with certain embodiments of the present disclosure;

FIG. 2 is a diagram of a user interface for analytics service governance, in accordance with certain embodiments of the present disclosure;

FIG. 3 is a diagram of a user interface for analytics service governance, in accordance with certain embodiments of the present disclosure;

FIG. 4 is a diagram of a user interface for analytics service governance, in accordance with certain embodiments of the present disclosure;

FIG. 5 depicts a flowchart of an example method to perform analytics service governance, in accordance with certain embodiments of the present disclosure; and

FIG. 6 is a diagram of a system configured to implement contextual recommendations for data visualizations, in accordance with certain embodiments of the present disclosure.

Some components or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

In the following detailed description of certain embodiments, reference is made to the accompanying drawings which form a part hereof, and in which are shown by way of illustration of example embodiments. It is also to be understood that features of the embodiments and examples herein can be combined, exchanged, or removed, other embodiments may be utilized or created, and structural changes may be made without departing from the scope of the present disclosure. The following description and associated figures teach the best mode of the invention. For the purpose of teaching inventive principles, some aspects of the best mode may be simplified or omitted.

In accordance with various embodiments, the methods and functions described herein may be implemented as one or more software programs running on a computer processor or controller. Dedicated hardware implementations including, but not limited to, application specific integrated circuits, programmable logic arrays, and other hardware devices can likewise be constructed to implement the methods and functions described herein. Methods and functions may be performed by modules or nodes, which may include one or more physical components of a computing device (e.g., logic, circuits, processors, etc.) configured to perform a particular task or job, or may include instructions that, when executed, can cause a processor to perform a particular task or job, or any combination thereof. Further, the methods described herein may be implemented as a computer readable storage medium or memory device including instructions that, when executed, cause a processor to perform the methods.

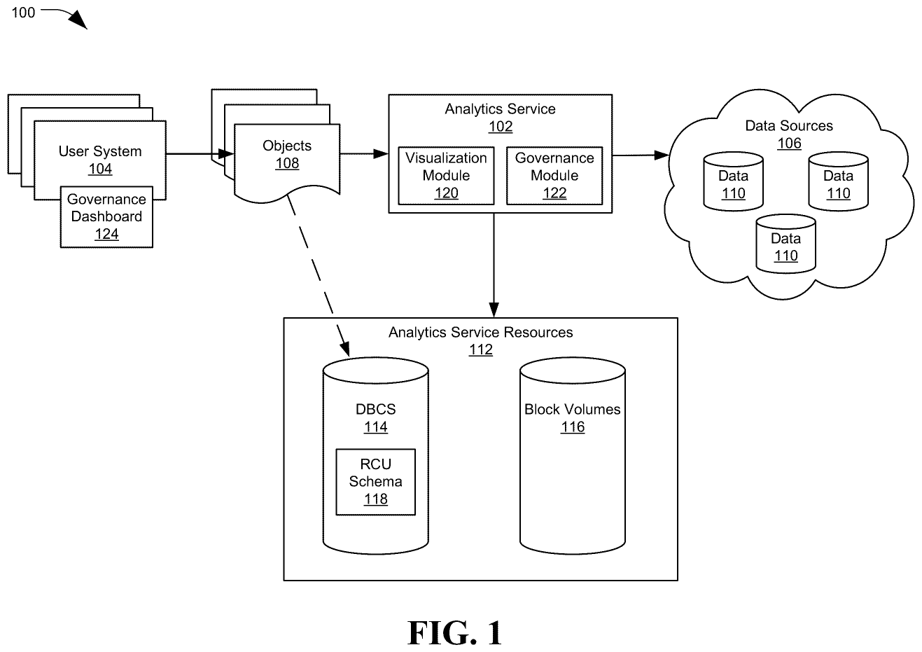

FIG. 1 is a diagram of a system 100 configured to implement analytics service governance, in accordance with certain embodiments of the present disclosure. Generally, data analytics enables the computer-based examination or analysis of large amounts of data, in order to derive conclusions or other information from that data, and business intelligence tools (BI) provide an organization's business users with information describing their enterprise data in a format that enables those business users to make strategic business decisions. Data analytics and BI tools can be provided within the context of enterprise software application environments or within the context of software-as-a-service (SaaS) or cloud environments, such as, for example, Oracle Analytics Cloud (OAC) or Oracle Cloud Infrastructure environment, Oracle Analytics Server (OAS) or other on-premises platform, Oracle Business Intelligence Applications (OBIA), Oracle Business Intelligence Enterprise Edition (OBIEE), Oracle Business Intelligence Server (OBIS), an Oracle Fusion Applications environment, or other types of analytics application or cloud environments. Software vendors may offer enterprise software products or components as SaaS or cloud-oriented offerings, such as, for example, Oracle Fusion Applications; while other enterprise software products or components, such as, for example, Oracle Autonomous Data Warehouse (ADW) or Oracle Autonomous Data Warehouse Cloud (ADWC), can be offered as one or more of SaaS, platform-as-a-service (PaaS), or hybrid subscriptions.

In accordance with an embodiment, a data warehouse environment or component, such as, for example, an Oracle ADW, Oracle ADWC, or other type of data warehouse environment or component adapted to store large amounts of data, can provide a central repository for storage of data collected by one or more business applications. For example, in accordance with an embodiment, the data warehouse environment or component can be provided as a multi-dimensional database that employs online analytical processing (OLAP) or other techniques to generate business-related data from multiple different sources of data. An organization can extract such business-related data from one or more vertical or horizontal business applications, and inject the extracted data into a data warehouse instance that is associated with that organization. Horizontal business applications can provide a broad scope of functionality across various enterprise organizations, and may include ERP (enterprise resource planning), HCM (human capital management), CX (customer experience), SCM (supply chain management), and EPM (enterprise performance management). Vertical business applications are generally narrower in scope that horizontal business applications, but may provide access to data that is further up or down a chain of data within a defined scope or industry. Examples of vertical business applications can include medical software, or banking software, for use within a particular organization.

The example system 100 may include a data analytics and visualization system such as Oracle Analytics Cloud (OAC), Oracle Analytics Server (OAS) and Fusion Data Intelligence Platform (FDIP), although the present disclosure may apply to other data visualization systems. The system 100 may include an analytics service 102, one or more user systems 104, one or more data sources 106 including collections of user-supplied data 110, one or more database or catalog objects 108, and analytics service resources 112 on which the analytics service 102 runs or relies on for functioning. Elements of system 100 may be implemented via computers, servers, hardware and software modules, or other system components. Elements of system 100 may also include or have access to one or more data storage devices, data storage mediums, data storage servers, and related data structures such as databases, which may store data files, executable code, or other information.

User system 104 may include a client or user device via which a human operator may access and interact with analytics service 102. User system 104 may access analytics service 102 via a network, which may include a wide area network (WAN) such as the internet, or a local area network (LAN) or intranet such as an office network. Analytics service 102 may be hosted remotely from user system 104, such as via a cloud service, or may be an on-premises service hosted at local servers or computing systems. In some examples, analytics service 102 may be implemented as software running on a user system 104. A user may interact with the analytics service 102 via a user interface (UI) presented via user system 104. User systems 104 may include desktop computers, laptop computers, servers, smart personal devices, or other computing systems.

Data sources 106 may include one or more collections of data 110 that may be provided, uploaded, or linked to analytics service 102 (e.g., via a network). Data sources 106 may include computer files (e.g., spreadsheet documents or database files), computer applications, cloud storage services, database hosting services, or other sources from which data 110 may be provided or accessed. Data 110 may include the actual information from the data sources 106. For an example of a business entity, the data 110 may include customer lists, sales data, shipping information, invoice information, employment records, or other data elements relevant to the business operations. A user may upload data 110 from the data sources 106 to the analytics service 102, over one or more networks, via a UI of user system 104 or analytics service 102. Data sources 106 of data 110 may be referred to as user data, including user-supplied files and records, as opposed to system data created and used to run analytics service 102. System data may include metadata generated by analytics service 102 about user data 110, in order to track and maintain data associations, database schema, connections, and other information about how analytics service 102 organizes and uses user data 110.

System and operational data may be stored, managed, or executed via analytics service resources 112. Analytics service resources 112 may include a database cloud service (DBCS) 114, block volumes 116, and may include other resources. The DBCS 114 may consist of database services running on virtual machine (VM) database systems, for application development, testing, and production deployment. The DBCS 114 may provide automation for common database lifecycle management tasks, such as updating, backup/recovery, and managing security features, and may be accessed using a UI console or REST APIs (application programming interfaces). Block volumes 116 may include virtual or detachable physical block storage devices providing adjustable capacity data storage for analytics service instances.

Operational and system metadata for analytics service 102 may be stored within the DBCS 114 under a repository creation utility (RCU) schema or database 118. The RCU schema 118 may include the systems and storage for creating, managing, and storing database schemas. A database schema may refer to the logical and visual configuration of an entire relational database. The database objects may be grouped and displayed as tables, functions, and relations, and a schema describes the organization and storage of data in a database and defines the relationship between various tables. Systems and components of analytics service 102 may depend on the existence of schemas in a database prior to installation or execution. Accordingly, the analytics service 102 may utilize system data and metadata to function, and the system data and metadata may be stored at and managed by RCU schema 118. User systems 104 may be able to view and modify user data 110, but due to various security, operational, and privacy considerations, users (including both regular users and system administrators) may have extremely limited or no access to the RCU schema database 118 and the system-level information it contains. For example, in a cloud service environment, the RCU schema 118 may not be exposed to users, and may be managed by the analytics service 102 service provider. In an on-premises deployment, the RCU schema 118 may be created and maintained by customers on supported databases, but the proprietary metadata stored in the RCU database may not be usable by the users.

Users, via user system 104, may create, manage, and use objects 108 through the analytics service 102 interface as a means of interacting with data sources 106 and user data 110. Objects 108 may include various types of user-created data structures and functions, such as connections, datasets, schedulers, data models, dataflows, jobs/schedulers or agents, analyses, DV workbooks, prompts, publisher objects, reports, catalogs, etc., which may have their metadata and other elements stored within RCU schema 118. In addition, various other metadata such as access control lists (ACLs) for each object 108, and any specific object-level options, may also be maintained within the RCU Schema 118.

The analytics service 102 may store and retrieve metadata of user-created objects 108 in the RCU schema 118. Other operational and administration-related metadata like user profiles, roles, and privileges may also be stored in the RCU schema 118. Similarly, system settings and configuration parameters for the analytics service 102 may also be stored in the RCU schema 118. Objects 108 may have a limited scope visible only to the permitted users or owners, as the RCU Schema 118 information may generally be highly restricted with minimal exposure via object listing. Due to the limited access to information within RCU schema 118, even administrators may not have system-wide knowledge of objects 108 and their metadata stored in RCU schema 118, thus curtailing their ability to understand, examine or analyze the objects at the analytics system level, which may be needed for efficient system administration.

Analytics service 102 may include a data analytics software application or system configured to gather and transform user data 110, and then present aspects of the data to clients in the form of one or more visualizations (e.g., via a UI of user system 104). Accordingly, analytics service 102 may include a visualization module 120.

The visualization module 120 may be configured to generate data visualizations (DVs, or just “visualizations”) to represent values from various columns of the dataset. Visualizations may include graphs, charts, diagrams, or other visual representations of data. For example, visualizations may include a bar chart of sales by customer segment, a heat map of sales by region, or other visual depictions of one or more of the columns from the dataset. By analyzing various visualizations, a user may be able to better grasp how various pieces of data from the dataset interrelate, and make better informed decisions. The visualization module 120 may present a user with pre-configured visualization options that the user can view (e.g., designed or selected by an author persona of a business client). In some examples, the visualization module 120 may present a user with tools for selecting data columns and creating a visualization model by which to view the data. Visualizations, and optional design tools, may be presented to a user via a UI of user system 104. A user may create select multiple visualizations to retain, which collection of visualizations may be called a workbook, dashboard, canvas, or other term.

An administrator (or “Admin”) of analytics service 102 may have greater access to system details for analytics service 102 than a standard user, such as having the ability to create and manage user profiles. In some embodiments, an admin may be able to view or monitor details of the physical components of a computing system running an analytics service 102 instance, such as CPU and memory usage. However, as noted above, an admin may only be able to see what's public within the analytics service 102, but they may be unable to see what is created by other users. Due to the system-level and operational details of analytics service 102 being stored in protected RCU schema 118, the admin may be limited in being able to diagnose what is happening in the analytics service to cause performance issues such as slowdowns or CPU spikes, or to answer other questions about how the analytics service is being used or the relationship between objects 108.

Accordingly, analytics service 102 may include a governance module 122. The governance module 122 may include systems and processes to utilize the capabilities of analytics service 102 to provide data analytics and visualization of information from RCU schema 118 to users, such as administrators, for example through user system 104. Governance module 122 may expose object 108 details and metadata and their relationships with other objects 108, and may empower analytics admins or authorized users to examine and filter the objects 108 metadata for efficient analytics administration.

Governance module 122 may solve the limitation or problem administrators are facing by accessing the information about objects 108 within RCU Schema 118, and translating it into actionable items in the form of various visualizations or dashboards. The object 108 and metadata-based visualizations may help administrators or other authorized users to examine, analyze, filter, and partition the system level object 108 information for efficient administration, governance, and analysis of their analytics system. Without such an interface, administrators may be unable to access system-wide information. Governance module 122 may be configured to expose objects 108 and their metadata to administrators only to the extent of seeing the object's existence plus metadata, and may not expose sensitive information or allow execution of objects.

Governance module 122 can use RCU schema database 118 as a hidden dataset, and may provide a selection of pre-configured DV options to provide users with useful insights into objects 108 and their usage within analytics service 102. The governance module 122 may therefore provide admins insights into how the analytics service 102 is being used, including usage trends that may impact the performance of the analytics service. The governance module 122 may provide admins with a way to see a number of objects 108 by type, who's creating what, etc. For example, metadata included in RCU database 118 about objects 108 may reveal when various recurring jobs or tasks are scheduled to be performed, and the users associated with those objects. Based on this information, the admin may be able to identify object-based activity that may be affecting system performance at specific times, determine object tasks at those times that could be rescheduled or deleted, and the users associated with the tasks. The admin could then contact the associated users in order to request the rescheduling or deletion of objects or tasks. Because the DV options from the governance module may be pre-configured, it may provide users with access to useful details from the RCU schema 118, without exposing sensitive or protected information. Further, a user may still be unable to directly query or access the RCU schema 118, and instead controlled access may be provided only through the governance module 122. The governance module 122 may therefore utilize the data analysis and visualization capabilities of analytics service 102 (e.g., via visualization module 120) to present system-level and system-wide details on the functioning and objects of analytics service 102.

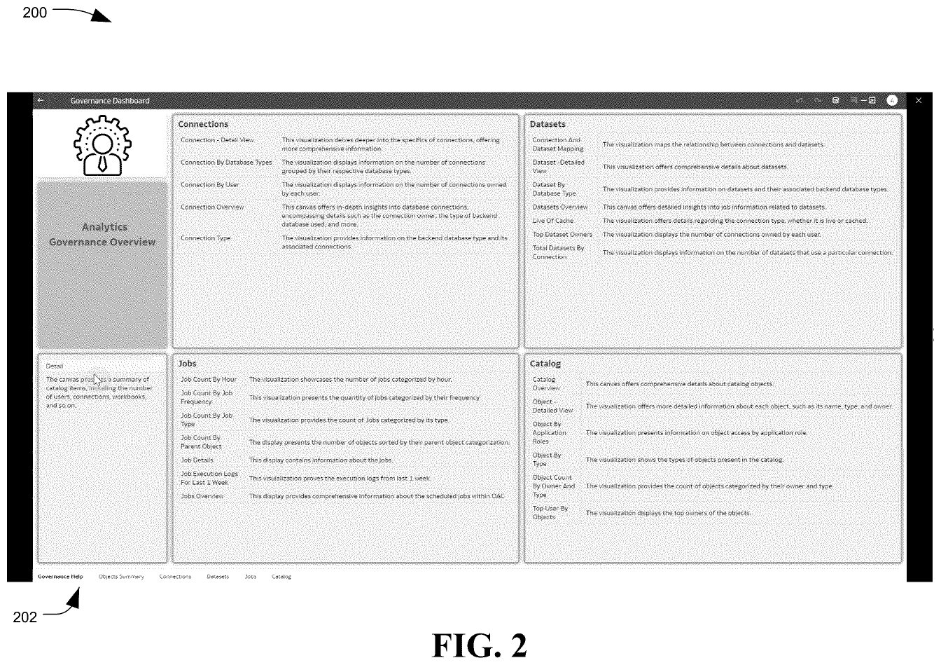

The governance module 122, potentially in conjunction with visualization module 120, may generate and present a governance dashboard 124, for example via an analytics service 102 UI at user system 104. The governance dashboard 124 may provide a way for users to select from the pre-configured DVs and information from the RCU schema 118. On the governance dashboard 124, a user may be able to display multiple visualizations or obtain other authorized information about objects created by other users and system-wide and system-level information. In some examples, the governance dashboard 124 may only be available to users having selected or admin-level privileges or authorization with the analytics service 102. Example embodiments of governance dashboard 124 are depicted in FIGS. 2-4. The governance dashboards in FIGS. 2-4 may be example embodiments of governance dashboard 124 of FIG. 1

FIG. 2 is a diagram 200 of a user interface for analytics service governance, in accordance with certain embodiments of the present disclosure. In particular, diagram 200 may depict an example governance dashboard user interface (UI) that may provide users with curated or pre-generated access functionality to portions of a repository creation utility (RCU) schema database including metadata and information about objects and system-level data. The governance dashboard of diagram 200 may provide read-only access to the provided information, filters, and data visualizations (DVs), and in some examples may be available only to users with selected or administrator-level access rights or credentials.

The governance dashboard may be one of multiple dashboards or DV functionalities provided by an analytics service to a user. The governance dashboard itself may include multiple pages, tabs, or “canvases” providing different information or functionality. For example, the page options 202 depicted in diagram 200 may include a “governance help” or “overview” page (an example of which is depicted in diagram 200), an “objects summary” page, a “connections” page, a “datasets” page, a “jobs” page, and a “catalog” page.

The “objects summary” page may provide a summary of different types of objects at system-level. The “connections” page may provide a filter-enabled page providing system-wide connection details. The “datasets” page may provide a filter-enabled page for displaying datasets with important attributes and details. The “jobs” page may provide a comprehensive overview of scheduled jobs or tasks, dataflows, and sequences. The “catalog” page may provide a multi-dimensional overview of various types of catalog objects. Other types of pages showing other types of objects or information, and in different configurations, may be included in a governance dashboard. In some examples, a user may be able to customize how data is depicted or provided by a governance dashboard.

In the example “overview” or “help” page depicted in diagram 200, various types of visualizations available within the “connections,” “datasets,” “jobs,” and “catalog” pages are listed along with brief descriptions.

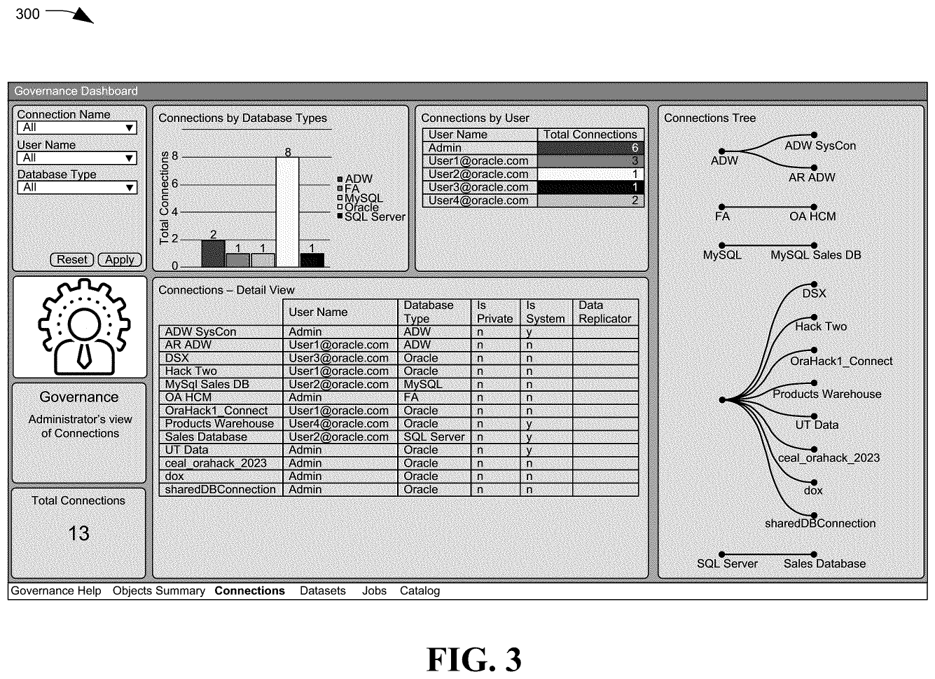

Turning now to FIG. 3, a diagram 300 of a user interface for analytics service governance is shown, in accordance with certain embodiments of the present disclosure. In particular, diagram 300 may be an example of a “connections” page on a governance dashboard, as described in regard to FIG. 2.

A “connection” may refer to an object containing the information needed to connect to a specific database. Each connection object may be associated with a particular user, such as a user that created the connection. The RCU schema database metadata accessible through the governance dashboard may provide details for the connection objects, such as a total number of connections system-wide in an analytics service instance, the type of databases for each connection, the users associated with each connection, a number of connections per user, connection name, and other metadata details on the connections. The information may be provided in the form of various types of DVs, including bar charts, tables, and connection trees.

In some embodiments, a user of the governance dashboard may not have access to the connected databases themselves, or the information included therein. However, the RCU schema database may include metadata about the connection object, and may provide a selected subset or all of that metadata through the governance dashboard of diagram 300. Because the DVs may be based on metadata from the protected RCU schema database, an administrator or authorized user may not have access to the depicted information (such as which user created each connection) without the governance dashboard.

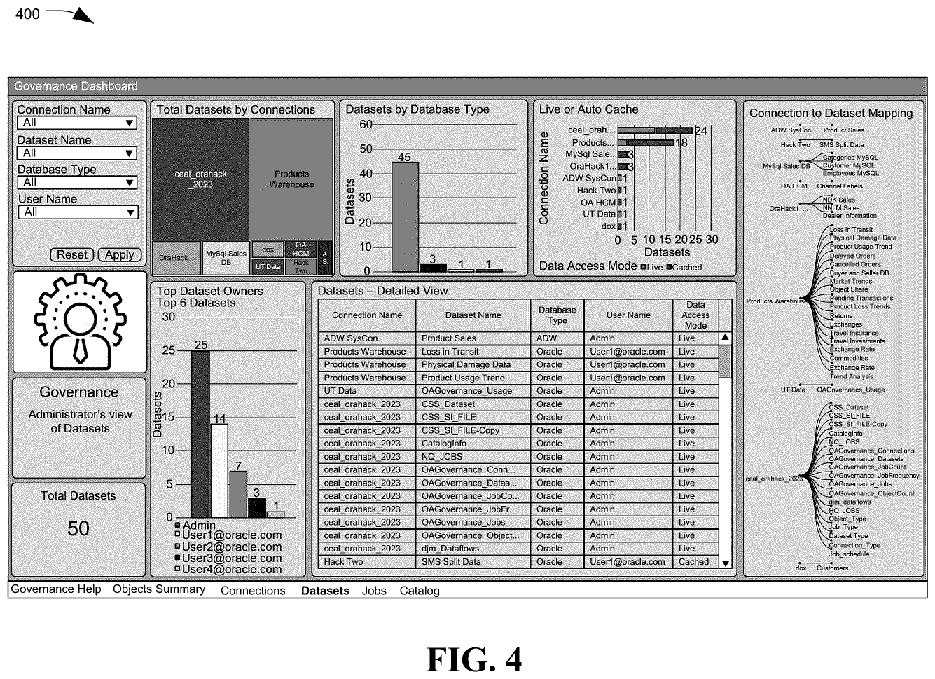

FIG. 4 is a diagram 400 of a user interface for analytics service governance, in accordance with certain embodiments of the present disclosure. In particular, diagram 400 may be an example of a “datasets” page on a governance dashboard, as described in regard to FIG. 2.

A dataset may refer to data from one or more database tables, files, or any other supported sources, or a collection of otherwise related data from one or more databases. Datasets may include objects identifying which related data from which databases or files are to be included in the dataset, and the database object may be associated with a user (e.g., that created the dataset object). The RCU schema database metadata accessible through the governance dashboard may provide details for the dataset objects, such as a total number of datasets, a number of datasets owned by each user, total datasets based on the connection(s) (e.g., which connected database) the dataset is associated with, dataset names, dataset types, and other metadata details on the datasets. As described above, this information may not be available to an administrator or authorized user outside of the governance DVs. The information may be provided in the form of various types of DVs, including bar charts, tables, and connection trees.

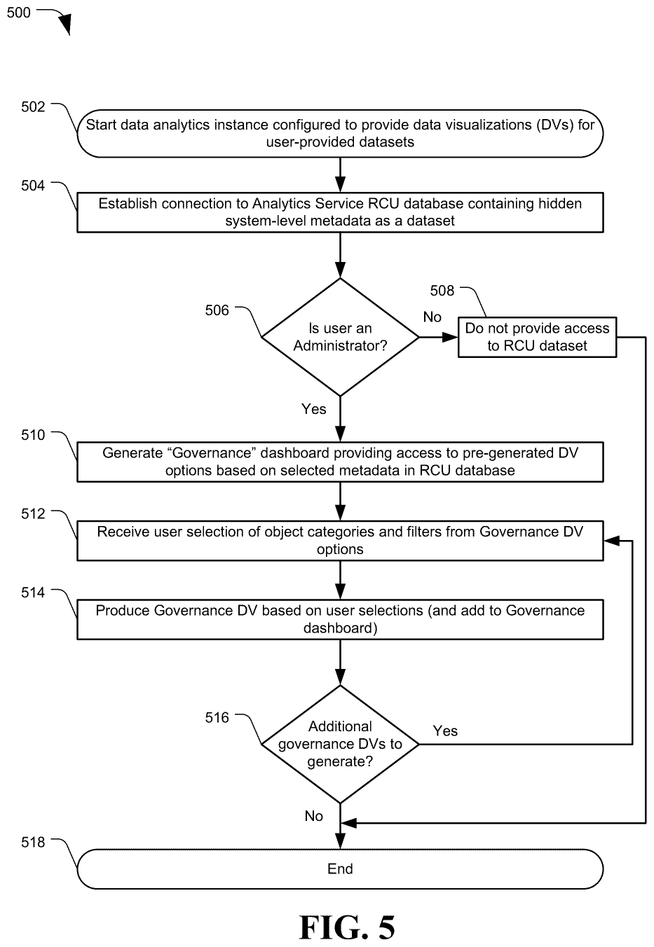

Other governance dashboard pages not depicted in FIGS. 2-4, such as for “jobs” or “catalogs”, may similarly depict read-only metadata about system-wide objects, based on pre-configured data visualizations, created from private or protected data from an RCU schema database in an analytics service system data. An example method for generating and presenting a RCU schema database information via a governance dashboard is described in regard to FIG. 5.

FIG. 5 depicts a flowchart 500 of an example method to perform analytics service governance, in accordance with certain embodiments of the present disclosure. In particular, FIG. 5 may illustrate a process flow by which system-wide object metadata and system level functional data of an analytics service can be securely presented via the data visualization functionality of the analytics service. The method may be performed by devices and systems described herein, such as analytics service 102, visualizations module 120, and governance module 122 of FIG. 1.

The method may start at 502, and may include starting a data analytics instance configured to provide data visualizations (DVs) for user-provided datasets. At 504, the method may include establishing a connection to an analytics service RCU database containing hidden system-level metadata as a dataset, including metadata about system-wide objects. The connection may be auto-created when a first REST call is issued to a dataset service (DSS) as part of instance provisioning, or during configuration of an instance.

A determination may be made whether a user is an administrator, or has a selected level of access rights, at 506. If not, the method may include not providing access to the RCU database, at 508, and ending the method at 518 (e.g., potentially allowing the user to only access basic user-level functionality of the analytics service).

If the user does have administrator clearance, at 506, the method may include generating a governance dashboard providing access to pre-generated DV options based on selected metadata in the RCU database, at 510. The selected metadata and pre-generated DV options may provide the administrator with metadata useful for governing the analytics instance, without exposing any sensitive, protected, or proprietary information from the RCU database. A user may not be able to query the RCU schema database directly, and instead may be limited to pre-configured options presented through the governance dashboard.

At 512, the method may include receiving a user selection of object categories and filters from the governance DV options. For example, the governance dashboard may provide a plurality of pages or canvases for different types or categories of object metadata, filters of what types of information to display, different visualizations of how the data should be depicted, and so forth. A user may select the options from drop-down menus, command line interfaces (CLIs), or other UI options. At 514, the method may include producing a governance DV based on the user selections, and may potentially include adding or saving the DV to a governance dashboard page.

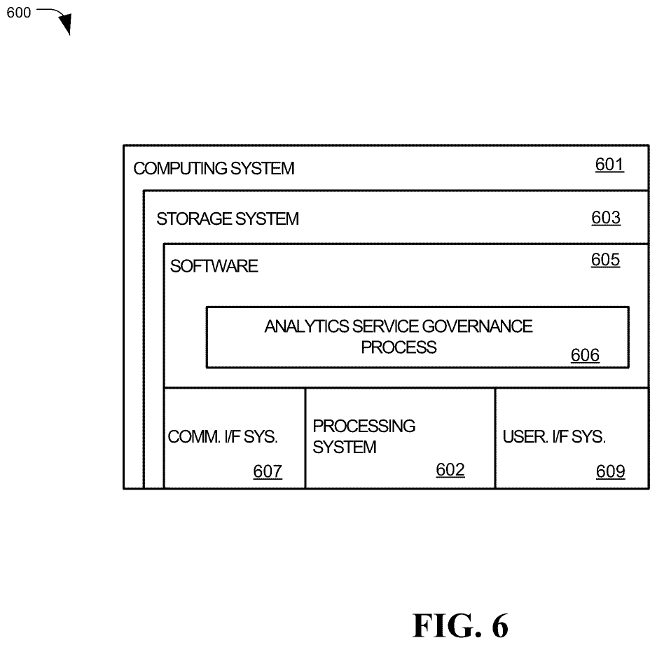

A determination may be made whether additional governance DVs are to be generated, at 516. For example, a user may select additional DV options to populate one or more governance dashboard pages with. If there are additional DVs to generate, the method may include returning to 512 to receive the user selections. If there are no additional DVs to generate, the method may end, at 518. A computing system configured to perform the operations and methods described herein is provided in regard to FIG. 6.

FIG. 6 illustrates an apparatus 600 including a computing system 601 that is representative of any system or collection of systems in which the various processes, systems, programs, services, and scenarios disclosed herein may be implemented. For example, computing system 601 may be an example of analytics service 102, visualization module 120, governance module 122, user system 104, data sources 106, analytics service resources 112, DBCS 114, RCU schema 118, or block volumes 116 of FIG. 1. Examples of computing system 601 include, but are not limited to, server computers, desktop computers, laptop computers, routers, switches, web servers, cloud computing platforms, and data center equipment, as well as any other type of physical or virtual server machine, physical or virtual router, container, and any variation or combination thereof.

Computing system 601 may be implemented as a single apparatus, system, or device or may be implemented in a distributed manner as multiple apparatuses, systems, or devices. Computing system 601 may include, but is not limited to, processing system 602, storage system 603, software 605, communication interface system 607, and user interface system 609. Processing system 602 may be operatively coupled with storage system 603, communication interface system 607, and user interface system 609.

Processing system 602 may load and execute software 605 from storage system 603. Software 605 may include and implement analytics service governance process 606, which may be representative of any of the operations for accessing a database of protected or restricted system-level metadata of a user-data analytics service, and presented selected metadata from the database via data visualization functionality of the analytics service, as discussed with respect to the preceding figures. When executed by processing system 602, software 605 may direct processing system 602 to operate as described herein for at least the various processes, operational scenarios, and sequences discussed in the foregoing implementations. Computing system 601 may optionally include additional devices, features, or functionality not discussed for purposes of brevity.

In some embodiments, processing system 602 may comprise a micro-processor and other circuitry that retrieves and executes software 605 from storage system 603. Processing system 602 may be implemented within a single processing device but may also be distributed across multiple processing devices or sub-systems that cooperate in executing program instructions. Examples of processing system 602 may include general purpose central processing units, graphical processing units, application specific processors, and logic devices, as well as any other type of processing device, combinations, or variations thereof.

Storage system 603 may comprise any memory device or computer readable storage media readable by processing system 602 and capable of storing software 605. Storage system 603 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 603 may also include computer readable communication media over which at least some of software 605 may be communicated internally or externally. Storage system 603 may be implemented as a single storage device but may also be implemented across multiple storage devices or sub-systems co-located or distributed relative to each other. Storage system 603 may comprise additional elements, such as a controller, capable of communicating with processing system 602 or possibly other systems.

Software 605 (including analytics service governance process 606 among other functions) may be implemented in program instructions that may, when executed by processing system 602, direct processing system 602 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 605 may include additional processes, programs, or components, such as operating system software, virtualization software, or other application software. Software 605 may also comprise firmware or some other form of machine-readable processing instructions executable by processing system 602.

In general, software 605 may, when loaded into processing system 602 and executed, transform a suitable apparatus, system, or device (of which computing system 601 is representative) overall from a general-purpose computing system into a special-purpose computing system customized to implement a bundled binding audit process as described herein. Indeed, encoding software 605 on storage system 603 may transform the physical structure of storage system 603. The specific transformation of the physical structure may depend on various factors in different implementations of this description. Examples of such factors may include, but are not limited to, the technology used to implement the storage media of storage system 603 and whether the computer-storage media are characterized as primary or secondary storage, as well as other factors.

For example, if the computer readable storage media are implemented as semiconductor-based memory, software 605 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 607 may include communication connections and devices that allow for communication with other computing systems (not shown) over communication networks (not shown). Examples of connections and devices that together allow for inter-system communication may include network interface cards, antennas, power amplifiers, radio-frequency (RF) circuitry, transceivers, and other communication circuitry. The connections and devices may communicate over communication media to exchange communications with other computing systems or networks of systems, such as metal, glass, air, or any other suitable communication media.

Communication between computing system 601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof.

While some examples provided herein are described in the context of Kubernetes containerized software environments, it should be understood the systems and methods described herein for configuration data management are not limited to such embodiments, and may apply to a variety of other containerized or virtualized software environments and their associated systems. As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more memory devices or computer readable medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all the following interpretations of the word: any of the items in the list, all the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A data analytics system, comprising:
one or more processors; and
a memory having stored thereon instructions that, upon execution by the one or more processors, cause the one or more processors to implement an analytics service governance process to generate data visualizations (DVs) of system-level metadata using an analytics service configured to generate DVs of user-provided datasets, the analytics service governance process including:
establish a connection to an analytics system database containing the system-level metadata as a dataset;
generate a governance dashboard providing access to pre-generated DV options based on selected metadata related to user-created objects in the analytics system database;
receive a user selection of object categories and filters from pre-generated DV options; and
produce a governance DV based on the user selection depicting a relationship of objects at the system level from the object categories.

2. The data analytics system of claim 1, wherein the system-level metadata includes system information generated by operation of the analytics service and required for the analytics service to function.

3. The data analytics system of claim 2, wherein the system-level metadata includes information about system-wide objects.

4. The data analytics system of claim 3, wherein:
the system-level metadata includes protected information not accessible to users; and
the pre-generated DV options based on the selected metadata are configured to not expose the protected information.

5. The data analytics system of claim 4, further comprising instructions that, upon execution, cause the one or more processors to:
establish the connection to the analytics system database via a hidden connection configured so that the analytics system database is not directly queryable by users.

6. The data analytics system of claim 5, further comprising instructions that, upon execution, cause the one or more processors to:
determine whether a user accessing the analytics service is an administrator having access rights to the governance dashboard; and
withhold access to the governance dashboard when the user is not an administrator.

7. The data analytics system of claim 6, wherein the governance DV depicts information about objects that influences a performance metric of the analytics service.

8. The data analytics system of claim 7, wherein the analytics service is deployed as a cloud-based service.

9. The data analytics system of claim 7, wherein the analytics service is deployed as an on-premises service.

10. The data analytics system of claim 7, further comprising instructions that, upon execution, cause the one or more processors to:
add the governance DV to the governance dashboard; and
add additional DVs produced based on the selected metadata from the analytics system database to the governance dashboard.

11. A method comprising:
operating a data analytics system to implement an analytics service governance process to generate data visualizations (DVs) of system-level metadata using an analytics service configured to generate DVs of user-provided datasets, the analytics service governance process including:
establishing a connection to an analytics system database containing the system-level metadata as a dataset;
generating a governance dashboard providing access to pre-generated DV options based on selected metadata related to user-created objects in the analytics system database;
receiving a user selection of object categories and filters from pre-generated DV options; and
producing a governance DV based on the user selection depicting a relationship of objects at the system level from the object categories.

12. The method of claim 11, wherein the system-level metadata includes system information generated by operation of the analytics service and required for the analytics service to function.

13. The method of claim 11, wherein the system-level metadata includes information about system-wide objects.

14. The method of claim 11, wherein:
the system-level metadata includes protected information not accessible to users; and
the pre-generated DV options based on the selected metadata are configured to not expose the protected information.

15. The method of claim 11, further comprising:
establishing the connection to the analytics system database via a hidden connection configured so that the analytics system database is not directly queryable by users.

16. The method of claim 11, further comprising:
determining whether a user accessing the analytics service is an administrator having access rights to the governance dashboard; and
not providing access to the governance dashboard when the user is not an administrator.

17. The method of claim 11, wherein the governance DV depicts information about objects that influences a performance metric of the analytics service.

18. The method of claim 11, wherein the analytics service is deployed as a cloud-based service.

19. The method of claim 11, wherein the analytics service is deployed as an on-premises service.

20. The method of claim 11, further comprising:
adding the governance DV to the governance dashboard; and
adding additional DVs produced based on the selected metadata from the analytics system database to the governance dashboard.
